(19) United States
(12) Patent Application Publication
(10) Pub. No.: US 2026/0357762 A1
(43) Pub. Date: Nov. 12, 2026

(54) CONTROL SYSTEM FOR INTERNAL COMBUSTION ENGINE

(71) Applicant: TOYOTA JIDOSHA KABUSHIKI KAISHA, Toyota-shi (JP)

(72) Inventors: Tomoko UDA, Kawasaki-shi (JP); Masato IKEMOTO, Sunto-gun (JP); Kentaro MINEO, Gotemba-shi (JP); Taku IBUKI, Susono-shi (JP)

(73) Assignee: TOYOTA JIDOSHA KABUSHIKI KAISHA, Toyota-shi (JP)

(21) Appl. No.: 19/442,330

(22) Filed: Jan. 7, 2026

(30) Foreign Application Priority Data
Mar. 17, 2025 (JP) 2025-042217

(51) Int. Cl. F02D 41/14

(52) U.S. Cl. CPC F02D 41/1465; F02D 41/1473; F02D 2200/023

(57) ABSTRACT

Included are an exhaust gas sensor detecting a component, and a control unit calculating an estimated value of the component and an estimation error between the estimated value and a detected value of the component. When the exhaust gas sensor is active, the control unit acquires a warm-up-related temperature related to warm-up state, stores a relation between the warm-up-related temperature after the exhaust gas sensor is activated and the estimation error, calculates a change point temperature where the relation between the warm-up-related temperature and the estimation error changes, finds a relational expression therebetween when the temperature is below the change point temperature, and stores the relational expression and the change point temperature, and when the exhaust gas sensor is not active, calculates a correction value for the estimated value by substituting the warm-up-related temperature into the relational expression, and correcting the estimated value of the component with the correction value.

### CROSS-REFERENCE TO RELATED APPLICATION

This application claims priority to Japanese Patent Application No. 2025-042217 filed on Mar. 17, 2025. The disclosure of the above-identified application, including the specification, drawings, and claims, is incorporated by reference herein in its entirety.

### BACKGROUND

### 1. Technical Field

The present disclosure relates to a control system for an internal combustion engine.

### 2. Description of Related Art

When estimating NOx concentration in exhaust gas of an internal combustion engine, there is known computing a reference NOx concentration value based on rotation speed and fuel injection amount of the internal combustion engine, and computing an estimated NOx concentration by correcting the reference NOx concentration based on fuel injection timing of the internal combustion engine (e.g., see Japanese Unexamined Patent Application Publication No. 2016-191308 (JP 2016-191308 A)).

### SUMMARY

An object of the present disclosure is to more accurately estimate concentration of exhaust gas components in low temperature regions in which sensors are inactive.

One aspect of the present disclosure is a control system for an internal combustion engine, the control system including an exhaust gas sensor for detecting a predetermined component in exhaust gas of the internal combustion engine, a control unit that calculates an estimated value of the predetermined component, and an estimation error that is a difference between the estimated value and a detected value of the predetermined component by the exhaust gas sensor, in which the control unit, in accordance with the exhaust gas sensor being active, executes acquiring a warm-up-related temperature that is a temperature related to a warm-up state of the internal combustion engine, storing a relation between the warm-up-related temperature after the exhaust gas sensor is activated and the estimation error, in a storage unit, calculating a change point temperature that is the warm-up-related temperature corresponding to a change point that is a point at which the relation between the warm-up-related temperature and the estimation error changes, in accordance with the relation between the warm-up-related temperature and the estimation error stored in the storage unit, finding a relational expression between the warm-up-related temperature and the estimation error when the temperature is lower than the change point temperature, and storing the relational expression and the change point temperature in the storage unit, and in accordance with the exhaust gas sensor not being active, executes calculating a correction value for the estimated value by substituting the warm-up-related temperature into the relational expression stored in the storage unit, and correcting the estimated value of the predetermined component in accordance with the correction value.

According to the present disclosure, the concentration of exhaust gas components can be estimated more accurately in low temperature regions in which the sensor is inactive.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of an engine and an exhaust system thereof, according to a first embodiment;

FIG. 2 is a diagram showing a relation between coolant temperature of the engine and estimation error;

FIG. 3 is a time chart showing transitions of estimated NOx concentration, actual NOx concentration, and corrected estimated NOx concentration when an NOx sensor is inactive;

FIG. 4 is a flowchart showing a control flow in an ECU;

FIG. 5 is a diagram showing the relation between the coolant temperature of the engine and the estimation error when the relation is consecutively plotted; and

FIG. 6 is a flowchart showing a control flow in the ECU.

### DETAILED DESCRIPTION OF EMBODIMENTS

There are problems with activating an NOx sensor disposed in an exhaust passage of an internal combustion engine to detect NOx concentration, immediately after starting the internal combustion engine, because there is a concern that durability thereof will deteriorate due to condensation water. On the other hand, there is demand for an ability to be able to comprehend the NOx concentration on-board, even though immediately after starting the internal combustion engine. Accordingly, immediately after starting the internal combustion engine, the NOx concentration is estimated based on operating state of the internal combustion engine, and so forth. However, the relation between the operating state of the internal combustion engine and the NOx concentration may change due to aging and so forth. In this case, error can occur in an estimated value of the NOx concentration. Now, for example, it is conceivable to correct a detection value of the NOx sensor before activation thereof, based on the detection value after activation of the NOx sensor, but since the tendency of NOx emissions differs between when the internal combustion engine is cold and when warm, and accordingly how to perform the correction becomes problematic. Note that the same problem can occur not only in NOx sensors but also in other sensors that detect components in exhaust gas. A control system for an internal combustion engine according to one aspect of the present disclosure solves this problem.

A control system for an internal combustion engine according to one aspect of the present disclosure, including an exhaust gas sensor that detects a predetermined component in exhaust gas of the internal combustion engine, and a control unit that calculates an estimated value of the predetermined component and an estimation error that is a difference between a detected value of the predetermined component by the exhaust gas sensor and the estimated value. Examples of the exhaust gas sensors include an NOx sensor that detects NOx concentration, an air-fuel ratio sensor that detects air-fuel ratio, an oxygen sensor that detects oxygen concentration, an HC sensor that detects HC concentration, and a PM sensor that detects the amount of particulate matter (PM). The control unit estimates the concentration of the predetermined component based on, for example, operating state of the internal combustion engine (e.g., engine rotation speed and fuel injection amount) that correlates with the concentration of the predetermined component.

Also, when the exhaust gas sensor is activated, the control unit acquires a warm-up-related temperature, which is a temperature related to a warm-up state of the internal combustion engine. For the exhaust gas sensor to be active, means, for example, that the temperature at which the exhaust gas sensor element is activated has been reached. When the exhaust gas sensor is active, the exhaust gas sensor can detect the concentration of a predetermined component, but when the exhaust gas sensor is inactive, the exhaust gas sensor cannot detect the concentration of the predetermined component. Temperatures related to the warm-up state of the internal combustion engine include, for example, coolant temperature of the internal combustion engine, lubricating oil temperature of the internal combustion engine, exhaust passage temperature of the internal combustion engine, the exhaust gas NOx removal catalyst temperature of the internal combustion engine, exhaust gas temperature of the internal combustion engine, and so forth. This warm-up-related temperature is a temperature at which it is possible to determine whether the internal combustion engine is in a cold state or a warm state. When the internal combustion engine is in a warm state, the clearances of the various components of the internal combustion engine are at appropriate values, allowing the internal combustion engine to perform at its full potential.

The control unit also stores, in a storage unit, the relation between the warm-up-related temperature after the exhaust gas sensor is activated and the estimation error. After the internal combustion engine is started, the warm-up-related temperature gradually increases. The estimation error changes accordingly. The tendency of this estimation error to change differs depending on whether the internal combustion engine is cold or warm. Also, when the internal combustion engine is cold, the tendency for the estimation error to change is the same regardless of whether the exhaust gas sensor is active or not. Accordingly, when the exhaust gas sensor is not activated, it is not possible for the exhaust gas sensor to detect a predetermined component, but it is possible to find in advance the tendency for the estimation error to change when the internal combustion engine is cold and also the exhaust gas sensor is activated. Correcting the estimated value of the concentration of the predetermined component before the exhaust gas sensor becomes active, which will be calculated next time and thereafter, in accordance with this tendency, enables the concentration of the predetermined component to be estimated more accurately.

Here, the control unit calculates a change point temperature, which is a warm-up-related temperature corresponding to a change point that is a point at which the relation between the warm-up-related temperature and the estimated error changes, in accordance with the relation between the warm-up-related temperature and the estimated error stored in the storage unit. The change point is indicated by the warm-up-related temperature and the estimation error when the tendency of the estimation error changes. The change point temperature is the warm-up-related temperature at which the tendency of the estimation error changes.

The control unit also finds a relational expression between the warm-up-related temperature and the estimation error when the temperature is lower than the change point temperature. Furthermore, the control unit stores the relational expression and the change point temperature in the storage unit. In this way, once the relational expression and the change point temperature are stored in the storage unit, the estimation error can be calculated in accordance with the warm-up-related temperature and the relational expression, when the internal combustion engine is in a cold state the next time, and thereafter. That is to say, in response to the exhaust gas sensor being inactive, the control unit calculates a correction value for the estimated value by substituting the warm-up-related temperature into the relational expression stored in the storage unit. Further, the control unit corrects the estimated value of the predetermined component according to the correction value. Thus, the estimated value of concentration of a predetermined component when the internal combustion engine is cold can be corrected on-board.

Embodiments for carrying out this disclosure will be described in detail below, by way of example, with reference to the accompanying drawings. Note, however, that unless otherwise specified, the dimensions, materials, shapes, relative positions thereof, and so forth, of the components described in this embodiment, are not intended to limit the scope of this disclosure to those alone.

### First Embodiment

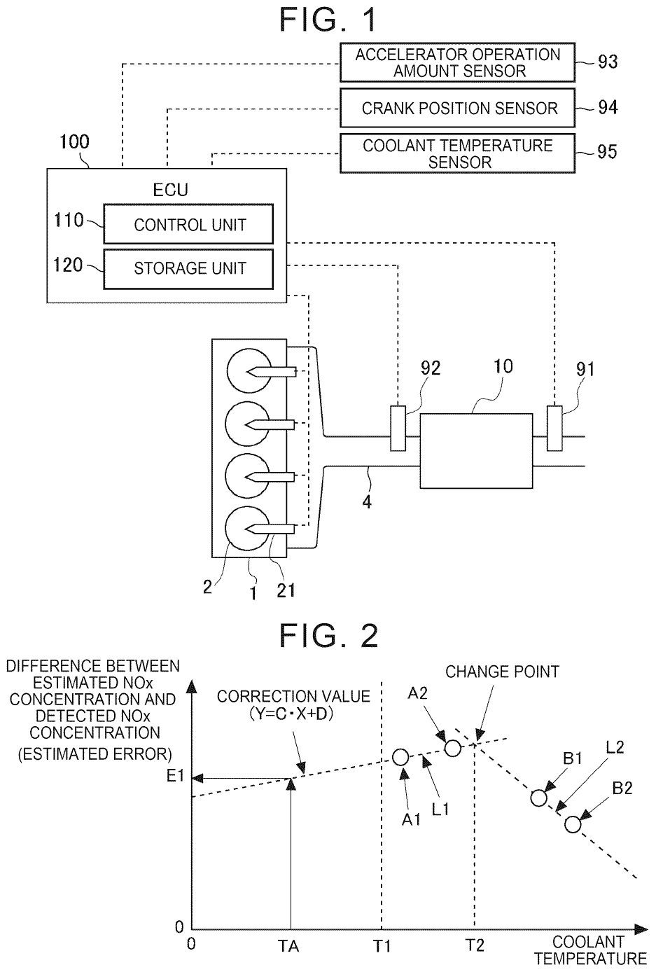

FIG. 1 is a diagram illustrating a schematic configuration of an engine and an exhaust system thereof, according to a first embodiment. An engine 1 illustrated in FIG. 1 is a water-cooled engine having, for example, four cylinders 2. Note that the engine 1 may be either of a gasoline engine or a diesel engine, for example. The engine 1 is installed in a vehicle, for example. The engine 1 is an example of an internal combustion engine.

A fuel injection valve 21 that injects fuel into the cylinder 2 is disposed in each cylinder 2 of the engine 1. Also, an exhaust passage 4 is connected to the engine 1. A catalyst 10 is provided partway along the exhaust passage 4. The catalyst 10 includes, for example, a DOC (oxidation catalyst), an SCR (selective catalytic reduction), an SCRF (a filter bearing an SCR catalyst), a TWC (three-way catalyst), an NSR (NOx storage-reduction catalyst), and so forth. A NOx sensor 91 that detects the NOx concentration in the exhaust gas is disposed in the exhaust passage 4 downstream from the catalyst 10. Also, an exhaust gas temperature sensor 92 for detecting the temperature of the exhaust gas is disposed in the exhaust passage 4 upstream from the catalyst 10. NOx is an example of a predetermined component. The NOx sensor 91 is an example of an exhaust gas sensor.

The engine 1 is connected to an ECU 100 which is an electronic control unit. The ECU 100 includes a control unit 110 and a storage unit 120. The control unit 110 can be implemented by a hardware processor, such as a central processing unit (CPU) or the like, for example. The control unit 110 may be configured including random access memory (RAM), read-only memory (ROM), cache memory, and the like. The storage unit 120 is means for storing information, and is made up of a storage medium such as RAM, flash memory, or the like. The storage unit 120 stores programs executed by the control unit 110, data used by these programs, and so forth. The ECU 100 controls the engine 1 in accordance with operating conditions of the engine 1 and requests of a driver.

Also, in addition to the NOx sensor 91 and the exhaust gas temperature sensor 92, the ECU 100 is also connected via electrical wiring to an accelerator operation amount sensor 93 that outputs electrical signals corresponding to the amount of the driver depressing an accelerator pedal and that can detect engine load, a crank position sensor 94 that detects engine rotation speed, and a coolant temperature sensor 95 that detects temperature of coolant of the engine 1, and output signals of these various sensors are input to the ECU 100.

Further, the ECU 100 is connected to each of the fuel injection valves 21 via electric wiring, and the control unit 110 of the ECU 100 controls fuel injection amount of fuel injected from the fuel injection valve 21.

The control unit 110 also estimates the NOx concentration in the exhaust gas. The NOx concentration in the exhaust gas has a correlative relation with the rotational speed and fuel injection amount of the engine 1, and accordingly the control unit 110 estimates the NOx concentration in the exhaust gas from the engine rotation speed detected by the crank position sensor 94 and the fuel injection amount from the fuel injection valve 21. The NOx concentration estimated in this manner will be referred to as estimated NOx concentration hereinafter. The relation among the engine rotation speed, the fuel injection amount, and the estimated NOx concentration is found in advance by experiment or simulation and is mapped, and stored in the storage unit 120. Note that the fuel injection amount is in a correlative relation with the accelerator operation amount, and accordingly the estimated NOx concentration can also be found in accordance with the detection value of the accelerator operation amount sensor 93 instead of the fuel injection amount. The fuel injection amount is calculated by the control unit 110 based on a command value transmitted from the control unit 110 to the fuel injection valve 21.

Also, the control unit 110 calculates a correction value for the estimated NOx concentration when the NOx sensor 91 is inactive. This correction value is found according to a difference between the estimated NOx concentration calculated when the NOx sensor 91 is active and the NOx concentration that is detected (hereinafter also referred to as detected NOx concentration). Note that in the following description, the difference between the estimated NOx concentration and the detected NOx concentration will also be referred to as estimation error. FIG. 2 is a diagram that shows a relation between coolant temperature of the engine 1, and the estimation error. T1 in the coolant temperature is a coolant temperature at which the NOx sensor 91 becomes active.

The control unit 110 acquires two sets of data when the engine 1 is cold and plots them on FIG. 2 (A1 and A2), and acquires two sets of data when warm and plots them on FIG. 2 (B1 and B2). The control unit 110 finds a line L1 passing through the two points A1 and A2 acquired when cold, and a line L2 passing through the two points B1 and B2 acquired when warm, respectively. Furthermore, the control unit 110 finds an intersection of the line L1 corresponding to when cold and the line L2 corresponding to when warm, as the change point.

Here, the NOx concentration in the exhaust gas relative to the coolant temperature exhibits different tendencies when the engine 1 is cold and when warm. Also, the NOx concentration when the NOx sensor 91 is not active exhibits the same tendency as the NOx concentration when the engine 1 is cold. Accordingly, the control unit 110 utilizes these tendencies to find a correction value for the estimated NOx concentration corresponding to the coolant temperature. A line L1 indicates the correlation between the coolant temperature and the estimation error at temperatures lower than the change point. Accordingly, even at a temperature lower than the coolant temperature T1 at which the NOx sensor 91 is activated, the relation between the coolant temperature and the estimation error follows the relational expression indicated by the line L1. Therefore, the control unit 110 finds a relational expression (Y=C·X+D) of the line L1. Note that here, Y is the estimation error, C is the gradient of the line L1, X is the coolant temperature, and D is the estimation error when the coolant temperature is 0. The control unit 110 stores the relational expression and the change point that are found, in the storage unit 120, and will find a correction value the next time the engine 1 is started.

As shown in FIG. 2, when the coolant temperature is lower than temperature T2 corresponding to the change point, substituting a value of coolant temperature TA into the relational expression of the line L1 enables an estimation error E1 corresponding to that coolant temperature to be found. That is to say, a relation of (E1=C·TA+D) holds. Also, a value obtained by subtracting the estimation error E1 from the estimated NOx concentration corresponds to the detected NOx concentration, and accordingly the control unit 110 calculates the estimated NOx concentration and corrects the estimated NOx concentration by subtracting the estimation error E1 from the estimated NOx concentration. This estimated NOx concentration that is corrected can be said to be the detected NOx concentration when presuming that the NOx sensor 91 is active.

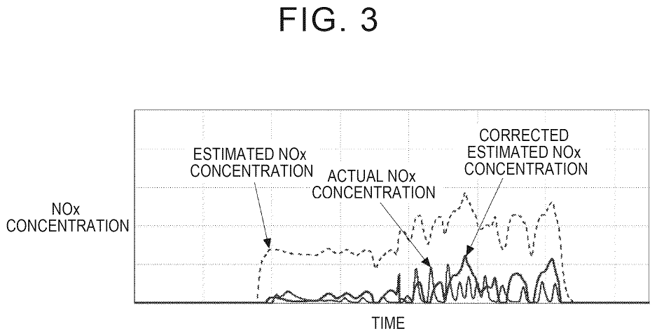

FIG. 3 is a time chart showing transition of estimated NOx concentration, actual

NOx concentration, and the estimated NOx concentration that is corrected, when the NOx sensor 91 is inactive. The actual NOx concentration is the NOx concentration actually detected through experimentation. It can be seen that although the difference between the actual NOx concentration and the estimated NOx concentration is great, the difference between the actual NOx concentration and the estimated NOx concentration that is corrected is small. Thus, confirmation was made through experiments that the correction of the estimated NOx concentration according to the present disclosure is effective.

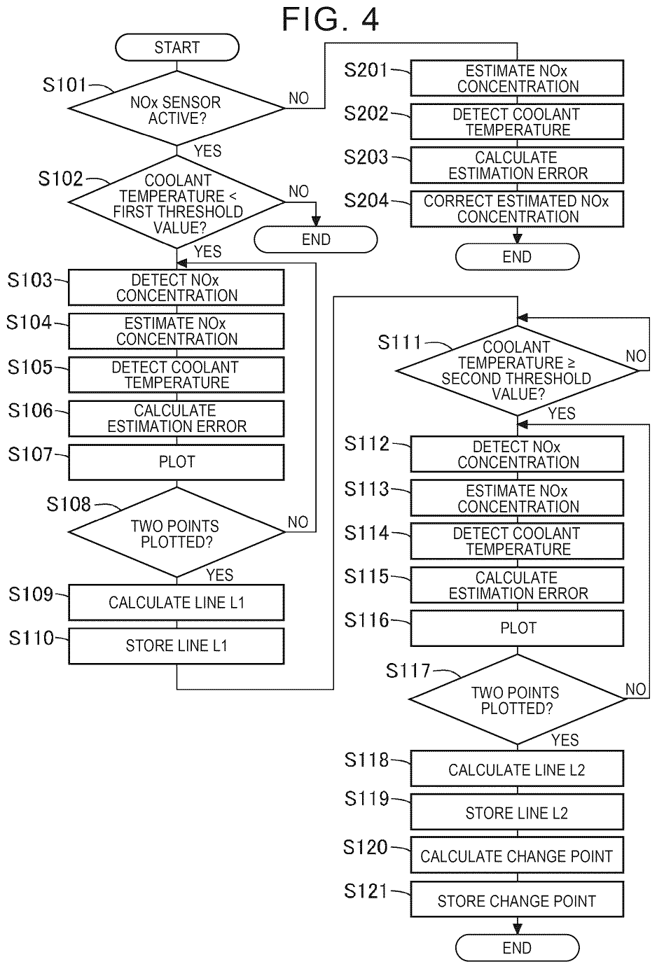

FIG. 4 is a flowchart showing a control flow in the ECU 100. A routine shown in FIG. 4 is executed in the ECU 100, triggered by the engine 1 being started. In step S101, the control unit 110 determines whether the NOx sensor 91 is active. For example, in a case in which the NOx sensor 91 is provided with a temperature sensor, the control unit 110 determines that the NOx sensor 91 is activated in accordance with the temperature detected by this temperature sensor being equal to or higher than an activation temperature. Also, as another example, the control unit 110 may estimate the amount of heat supplied to the NOx sensor 91, for example, from a detection value of the exhaust gas temperature sensor 92, and engine rotation speed and fuel injection amount history, and estimate the temperature of the NOx sensor 91 from this amount of heat. This estimation can be performed using known logic. Furthermore, in a case in which the NOx sensor 91 is equipped with a heater, the control unit 110 may determine that the NOx sensor 91 is activated when a predetermined amount of time or more has elapsed since the heater started heating. The predetermined amount of time is found by experiment, simulation, or the like, as the time until the NOx sensor 91 becomes active, and is stored in the storage unit 120. Also, since the temperature of the NOx sensor 91 is correlated with the coolant temperature of the engine 1, the control unit 110 may determine that the NOx sensor 91 is active when the coolant temperature is a temperature that corresponds to the activation temperature of the NOx sensor 91. The coolant temperature corresponding to the activation temperature of the NOx sensor 91 in this case corresponds to the temperature indicated by T1 in FIG. 2. When the control unit 110 makes an affirmative determination in step S101, the processing advances to step S102, and when a negative determination is made, the processing advances to step S201.

In step S102, the control unit 110 determines whether the coolant temperature is lower than a first threshold value. The first threshold value is a coolant temperature at which the engine 1 is considered to be in a cold state, and is a temperature lower than the temperature that is a boundary between when the engine is cold and when warm. Here, the control unit 110 determines whether the cooling coolant temperature exhibits the same tendency as the relation between the coolant temperature and the estimation error when cold. When the control unit 110 makes an affirmative determination in step S102, the processing advances to step S103, and when making a negative determination, this routine ends. Now, when the coolant temperature is equal to or higher than the first threshold value, the line L1 corresponding to when cold cannot be calculated, and accordingly this routine is ended.

In step S103, the control unit 110 detects the NOx concentration using the NOx sensor 91. When the processing of step S103 is completed, the processing advances to step S104. In step S104, the control unit 110 estimates the NOx concentration. The control unit 110 estimates the NOx concentration in the exhaust gas from the engine rotation speed detected by the crank position sensor 94, the fuel injection amount from the fuel injection valve 21, and a map stored in the storage unit 120. When the processing of step S104 is completed, the processing advances to step S105.

In step S105, the control unit 110 detects the coolant temperature using the coolant temperature sensor 95. When the processing of step S105 is completed, the processing advances to step S106. In step S106, the control unit 110 calculates estimation error. The control unit 110 calculates the difference between the estimated NOx concentration calculated in step S104 and the detected NOx concentration acquired in step S103, thereby calculating the estimation error. When the processing of step S106 is completed, the processing advances to step S107.

In step S107, the control unit 110 plots points corresponding to the coolant temperature acquired in step S105 and the estimation error calculated in step S106 on a graph shown in FIG. 2, with the horizontal axis representing the coolant temperature and the vertical axis representing the estimation error. When the processing of step S107 is completed, the processing advances to step S108.

In step S108, the control unit 110 determines whether two points are plotted in the graph shown in FIG. 2, in which the horizontal axis represents the coolant temperature and the vertical axis represents the estimation error, during cold operation. When the control unit 110 makes an affirmative determination in step S108, the processing advances to step S109, and when a negative determination is made, the processing returns to step S103. Note that the returning of the processing to step S103 may be performed after a certain amount of time has elapsed. That is to say, when the control unit 110 calculates the line L1 by acquiring data from two points at which the coolant temperatures are similar, this line will be more susceptible to influence of external disturbances and so forth, and accordingly acquiring information from the second point in a state in which the coolant temperature has changed to a certain extent enables a more appropriate line L1 to be calculated. Also, as another example, the coolant temperatures at which data is to be acquired twice may be set in advance. These coolant temperatures may be found by experiment or simulation, and stored in the storage unit 120, such that the line L1 can be found with high precision.

In step S109, the control unit 110 calculates the relational expression corresponding to the line L1 that passes through the two points that are plotted. Further, in step S110, the control unit 110 stores the relational expression corresponding to the line L1 in the storage unit 120. When the processing of step S110 is completed, the processing advances to step S111. Note that the relational expression corresponding to the line L1 corresponds to a first relational expression.

In step S111, the control unit 110 determines whether the coolant temperature is equal to or higher than a second threshold value. The second threshold value is a coolant temperature at which the engine 1 is considered to be in a warm state, and is a temperature higher than the temperature that is a boundary between when the engine is cold and when warm. Here, the control unit 110 determines whether the coolant temperature exhibits the same tendency as the relation between the coolant temperature and the estimation error when warm. Note that the second threshold value is a temperature higher than the first threshold value, but as another example, the second threshold value may be the same temperature as the first threshold value. When the control unit 110 makes an affirmative determination in step S111, the processing advances to step S112, and when making a negative determination, the control unit 110 executes the processing of step S111 again. Thus, the control unit 110 stands by until the coolant temperature becomes equal to or higher than the second threshold value.

In step S112, the control unit 110 detects the NOx concentration using the NOx sensor 91. When the processing of step S112 is completed, the processing advances to step S113. In step S113, the control unit 110 estimates the NOx concentration. When the processing of step S113 is completed, the processing advances to step S114. In step S114, the control unit 110 detects the coolant temperature using the coolant temperature sensor 95. When the processing of step S114 is completed, the processing advances to step S115.

In step S115, the control unit 110 calculates the estimation error. The control unit 110 calculates the difference between the estimated NOx concentration calculated in step S113 and the detected NOx concentration acquired in step S112, thereby calculating the estimation error. When the processing of step S115 is completed, the processing advances to step S116.

In step S116, the control unit 110 plots points corresponding to the coolant temperature acquired in step S114 and the estimation error calculated in step S115 on the graph shown in FIG. 2, in which the horizontal axis represents the coolant temperature and the vertical axis represents the estimation error. When the processing of step S116 is completed, the processing advances to step S117.

In step S117, the control unit 110 determines whether two points are plotted in the graph shown in FIG. 2, in which the horizontal axis represents the coolant temperature and the vertical axis represents the estimation error, when warm. When the control unit 110 makes an affirmative determination in step S117, the processing advances to step S118, and when a negative determination is made, the processing returns to step S112. Note that returning of the processing to step S112 may be performed after a certain amount of time has elapsed. Also, as another example, the coolant temperatures at which data is to be acquired twice may be set in advance. These coolant temperatures may be found by experiment or simulation, and stored in the storage unit 120, such that the line L2 can be found with high precision.

In step S118, the control unit 110 calculates a relational expression corresponding to the line L2 that passes through the two points that are plotted. Further, in step S119, the control unit 110 stores the relational expression corresponding to the line L2 in the storage unit 120. When the processing of step S119 is completed, the processing advances to step S120. Note that the relational expression corresponding to the line L2 corresponds to a second relational expression.

In step S120, the control unit 110 calculates the change point, which is the intersection of the line L1 and the line L2. At this time, the control unit 110 calculates the coolant temperature corresponding to the change point and the estimation error corresponding to the change point. When the processing of step S120 is completed, the processing advances to step S121. In step S121, the control unit 110 stores the change point calculated in step S120 in the storage unit 120. When the processing of step S121 is completed, this routine ends.

On the other hand, when the determination in step S101 is negative, the control unit 110 estimates the NOx concentration in step S201. At this time, the NOx sensor 91 is below the activation temperature thereof, and accordingly the NOx sensor 91 cannot detect the NOx concentration. When the processing of step S201 is completed, the processing advances to step S202. In step S202, the control unit 110 detects the coolant temperature using the coolant temperature sensor 95. When the processing of step S202 is completed, the processing advances to step S203.

In step S203, the control unit 110 calculates the estimation error. The control unit 110 calculates the estimation error by substituting the coolant temperature detected in step S202 into the relational expression corresponding to the line L1 stored in the storage unit 120. When the processing of step S203 is completed, the processing advances to step S204.

In step S204, the control unit 110 corrects the estimated NOx concentration by subtracting the estimation error calculated in step S203 from the estimated NOx concentration acquired in step S201. The estimated NOx concentration that is corrected may be stored in the storage unit 120 by the control unit 110. When the processing of step S204 is completed, this routine ends.

As described above, according to the present embodiment, the estimated NOx concentration in a state in which the NOx sensor 91 is inactive can be corrected in accordance with the relation between the coolant temperature and the estimation error found in the past in a state in which the NOx sensor 91 was active and also the engine 1 was cold. Accordingly, even when the NOx sensor 91 is in an inactive state, the NOx concentration can be estimated more accurately.

### Other Embodiments

In the first embodiment, description was made with the NOx sensor 91 as an example, but application can be made in the same way to other sensors that detect exhaust gas components, and that are not in an activated state at low temperatures.

In the first embodiment, the control unit 110 finds two points when cold and two points when warm, and finds the relational expressions corresponding to the line L1 and line L2, but the number of points found is not limited to two each. The control unit 110 may find three or more points, for example, and find a line corresponding to these three or more points. In this case, the line is not limited to being a straight line and may be a curved line. The line may also be found by regression analysis.

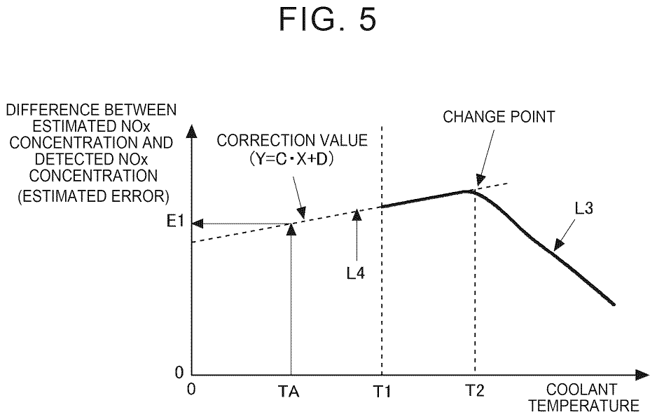

FIG. 5 is a diagram showing a relation between the coolant temperature of the engine 1 and estimation error when the relation is consecutively plotted. T1 in the coolant temperature is the coolant temperature when the NOx sensor 91 becomes active. The control unit 110 consecutively acquires data over a period from the cold state to the warm state of the engine 1 and inputs the data into the graph shown in FIG. 5. Thus, the control unit 110 obtains a single curve L3. The control unit 110 then extracts, for example, critical points and inflection points from the curve L3, as change points. In the example shown in FIG. 5, the maximum point corresponds to the change point. The coolant temperature corresponding to the change point is T2. The control unit 110 may calculate the relational expression in the region where the coolant temperature is lower than the maximum point.

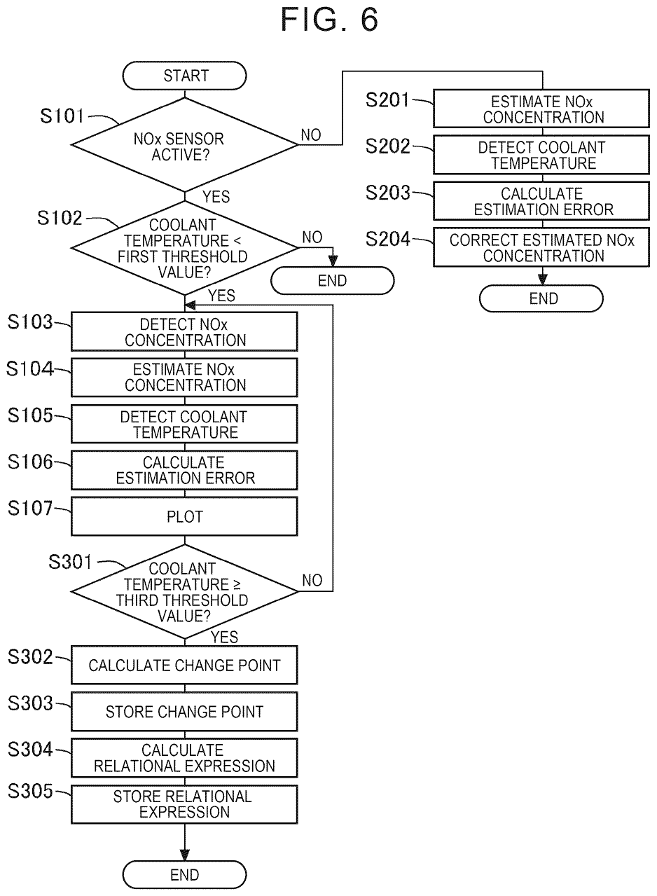

FIG. 6 is a flowchart showing a control flow in the ECU 100. A routine shown in FIG. 6 is executed in the ECU 100, triggered by the engine 1 being started. Note that in FIG. 6, steps in which the same processing as that shown in FIG. 4 is executed are denoted by the same reference numerals, and description thereof will be omitted. In the routine shown in FIG. 6, when the processing of step S107 ends, the processing advances to step S301.

In step S301, the control unit 110 determines whether the coolant temperature is equal to or higher than a third threshold value. The third threshold value is a coolant temperature at which the engine 1 is considered to be in a warm state, and is a temperature higher than the temperature that is the boundary between when cold and when warm. Note that the third threshold value may be a value that is the same as the second threshold value in step S111 of FIG. 4, or may be a value that is greater than the second threshold value. Here, the control unit 110 determines whether the coolant temperature has risen to a temperature at which the change point can be found. When the control unit 110 makes an affirmative determination in step S301, the processing advances to step S302, and when a negative determination is made, the processing returns to step S103. Note that the processing immediately returns to step S103. Here, when a negative determination is made in step S108 or step S117 in FIG. 4, the processing returns after a certain period of time has elapsed, however, in the routine shown in FIG. 6, the processing returns immediately in order to consecutively acquire data.

In step S302, the control unit 110 calculates the change point. The control unit 110 calculates, for example, a point at which a differential value of the curve L3 becomes 0, as the change point. When the processing of step S302 is completed, the processing advances to step S303. In step S303, the control unit 110 stores, in the storage unit 120, the coolant temperature and the estimation error corresponding to the change point calculated in step S302. When the processing of step S303 is completed, the processing advances to step S304.

In step S304, the control unit 110 calculates a relational expression corresponding to the curve L3 for when the coolant temperature is lower than the change point. The control unit 110 may calculate an approximation expression (Y=C·X+D) of the curve L3 for when the coolant temperature is lower than the change point. This calculation can be performed using known logic. When the processing of step S304 is completed, the processing advances to step S305. In step S305, the control unit 110 stores the relational expression calculated in step S304 in the storage unit 120. When the processing of step S305 is completed, this routine ends.

Also, in the above embodiment, the control unit 110 finds and updates the relational expression between the coolant temperature and the estimated error each time the engine 1 is started, but a relational expression that is intermediate between the relational expression found last time and the relational expression found this time may be found, for example, and a correction value for the estimated NOx concentration may be calculated. Also, the control unit 110 may store even more relational expressions in the storage unit 120, find an averaged relational expression thereof, and calculate the correction value for the estimated NOx concentration.

In the above embodiment, when the control unit 110 cannot plot two points when the engine is cold, the line L1 is not found. However, by finding the relation between the line L1 and the line L2 in advance, the line L1 can be calculated based on the line L2 found when warm.

In the above embodiment, the control unit 110 finds the estimation error in accordance with the coolant temperature of the engine 1, but the estimation error may also be found according to another temperature related to the warm-up state of the engine 1 (e.g., temperature of catalyst 10). Also, the control unit 110 may correct the estimated NOx concentration by further taking into consideration traveling conditions, such as the engine rotation speed, the fuel injection amount, and so forth.

What is claimed is:

1. A control system for an internal combustion engine, the control system comprising:
an exhaust gas sensor for detecting a predetermined component in exhaust gas of the internal combustion engine;
a control unit that calculates an estimated value of the predetermined component, and an estimation error that is a difference between the estimated value and a detected value of the predetermined component by the exhaust gas sensor, wherein
the control unit,
in accordance with the exhaust gas sensor being active, executes
acquiring a warm-up-related temperature that is a temperature related to a warm-up state of the internal combustion engine,
storing a relation between the warm-up-related temperature after the exhaust gas sensor is activated and the estimation error, in a storage unit;
calculating a change point temperature that is the warm-up-related temperature corresponding to a change point that is a point at which the relation between the warm-up-related temperature and the estimation error changes, in accordance with the relation between the warm-up-related temperature and the estimation error stored in the storage unit,
finding a relational expression between the warm-up-related temperature and the estimation error when the temperature is lower than the change point temperature, and
storing the relational expression and the change point temperature in the storage unit, and
in accordance with the exhaust gas sensor not being active, executes
calculating a correction value for the estimated value by substituting the warm-up-related temperature into the relational expression stored in the storage unit, and
correcting the estimated value of the predetermined component in accordance with the correction value.

2. The control system according to claim 1, wherein
storing the relation between the warm-up-related temperature after the exhaust gas sensor is activated and the estimation error, in the storage unit, includes
storing a first relation that is the relation between the warm-up-related temperature and the estimation error, in the storage unit at least twice after the exhaust gas sensor is activated and also before warm-up of the internal combustion engine is completed,
finding a first relational expression that is the relational expression between the warm-up-related temperature and the estimation error, in accordance with the first relation stored in the storage unit, and storing the first relational expression in the storage unit,
storing a second relation that is the relation between the warm-up-related temperature and the estimation error, in the storage unit at least twice after the exhaust gas sensor is activated and also after warm-up of the internal combustion engine is completed,
finding a second relational expression that is the relational expression between the warm-up-related temperature and the estimation error, in accordance with the second relation stored in the storage unit, and storing the second relational expression in the storage unit, and
calculating the change point temperature that is the warm-up-related temperature corresponding to the change point that is the point at which the relation between the warm-up-related temperature and the estimation error changes, in accordance with the relation between the warm-up-related temperature and the estimation error stored in the storage unit, includes calculating the change point temperature by calculating the warm-up-related temperature corresponding to an intersection point between the first relational expression and the second relational expression,
storing the relational expression and the change point temperature in the storage unit includes storing the first relational expression and the change point temperature in the storage unit,
calculating the correction value of the estimated value by substituting the warm-up-related temperature into the relational expression stored in the storage unit includes substituting the warm-up-related temperature into the first relational expression stored in the storage unit to calculate the correction value of the estimated value, and
correcting the estimated value of the predetermined component in accordance with the correction value includes correcting the estimated value by subtracting the correction value from the estimated value of the predetermined component.

3. The control system according to claim 1, wherein
storing the relation between the warm-up-related temperature and the estimation error after the exhaust gas sensor is activated, in the storage unit, includes consecutively storing the relation between the warm-up-related temperature and the estimation error in the storage unit over a period from after the exhaust gas sensor is activated and also before the warm-up of the internal combustion engine is completed, to after the exhaust gas sensor is activated and also after the warm-up of the internal combustion engine is completed,
calculating the change point temperature that is the warm-up-related temperature corresponding to the change point that is the point at which the relation between the warm-up-related temperature and the estimation error changes, in accordance with the relation between the warm-up-related temperature and the estimation error stored in the storage unit, includes calculating the change point temperature by calculating the warm-up-related temperature corresponding to a point at which a tendency of the relation between the warm-up-related temperature and the estimation error changes,
finding the relational expression between the warm-up-related temperature and the estimation error when the temperature is lower than the change point temperature includes finding a relational expression corresponding to the relation between the warm-up-related temperature and the estimation error when the temperature is lower than the change point temperature, and
correcting the estimated value of the predetermined component in accordance with the correction value includes correcting the estimated value by subtracting the correction value from the estimated value of the predetermined component.

4. The control system according to claim 1, further comprising a coolant temperature sensor for detecting the temperature of coolant of the internal combustion engine, wherein the warm-up-related temperature is a temperature detected by the coolant temperature sensor.

5. The control system according to claim 1, wherein the exhaust gas sensor is a NOx sensor that detects an NOx concentration in exhaust gas.
